(19) United States
(12) Patent Application Publication
(10) Pub. No.: US 2013/0044560 A1
(43) Pub. Date: Feb. 21, 2013

(54) WHISK HAVING RECONFIGURABLE WIRE LOOPS AND METHOD FOR BLENDING AND STIR-FRYING OF FOOD

(71) Applicants: Wai Kay HO, Hong Kong (HK); Chung Ming TONG, Hong Kong (HK)

(72) Inventors: Wai Kay HO, Hong Kong (HK); Chung Ming TONG, Hong Kong (HK)

(21) Appl. No.: 13/209,946

(22) Filed: Aug. 15, 2011

(51) Int. Cl. B01F 13/00

(52) U.S. Cl. 366/129

(57) ABSTRACT

A whisk has a handle and a plurality of nested ring members in rotatable engagement with each other at an end portion of the handle. Each ring member has a recess defined in a first circumferential edge, and a projection extending from the circumferential edge to be received in and slidable along a corresponding recess of an adjacent ring member. A plurality of wire loops is secured to the plurality of ring members, each wire loop being secured to a corresponding ring member. Rotation of the ring members in a first direction moves the wire loops to an expanded configuration, and rotation of the ring members in a second direction moves the wire loops to a collapsed configuration. A multi-purpose food-preparing utensil and a method for blending and stir-frying of food are also disclosed.

### TECHNICAL FIELD

The present invention generally relates to a kitchen utensil and particularly to a whisk having reconfigurable wire loops. The present invention also relates to a method for blending and stir-frying of food.

### BACKGROUND OF THE INVENTION

A whisk is a kitchen utensil commonly used for beating eggs. It can also be used in food preparation to blend ingredients into a mixture. The process is known as whisking or whipping. Conventional whisks consist of a handle with a plurality of wire loops provided at one end thereof. The wires are usually made of metal, but may be made of plastic for use with non-stick cookware.

However, these conventional whisks have limited function. They can only be used for whisking or blending during a food preparation process. Furthermore, they are difficult to clean especially when food is trapped in the partially enclosed area defined by the wire loops and between the wire loops of the wire whisk.

It is desirable to provide an improved and versatile whisk that has improved functionality, cost effective and convenient to clean after use.

### SUMMARY OF THE INVENTION

According to one aspect of the invention, there is provided a whisk comprising a handle and a plurality of nested ring members in rotatable engagement with each other at an end portion of the handle. Each ring member has a recess defined in a first circumferential edge, and a projection extending from the circumferential edge to be received in and slidable along a corresponding recess of an adjacent ring member. A plurality of wire loops is secured to the plurality of ring members, each wire loop being secured to a corresponding ring member. The wire loops are movable from an expanded configuration to a collapsed configuration. Rotation of the ring members in a first direction moves the wire loops to the expanded configuration, and rotation of the ring members in a second direction moves the wire loops to the collapsed configuration. In one embodiment, the wire loops in the expanded configuration is generally balloon-shaped suitable for egg beating or food blending, and the wire loops in the collapsed configuration is generally planar suitable for stir-frying of food.

In one embodiment, the plurality of ring members includes an innermost ring member fixedly connected to the handle, and an outermost ring member coupled with and rotatable by an annular knob. The annular knob may be coupled with the outermost ring member by a tubular coupling member. Each ring member comprises two longitudinal grooves defined in a second circumferential edge for receiving therein respectively two free ends of a corresponding wire loop. At least one free end of each wire loop has a bent portion received in a void extending in a circumferential direction from one of the longitudinal grooves such that the plurality of wire loops is non-detachably connected to the ring members. The two longitudinal grooves may be positioned opposite each other in the second circumferential edge.

Each projection may extend radially outwardly, and can be received in and slidable along a corresponding recess of an outer adjacent ring member. The plurality of ring members includes an innermost ring member having an elongated inner end formed with two opposite longitudinal slots for fitting onto a longitudinal wall extending diametrically inside the handle.

In one embodiment, there are five wire loops secured to five nested ring members, respectively. The first direction may be a clockwise direction and the second direction may be an anti-clockwise direction.

According to another aspect of the invention, there is provided a multi-purpose food-preparing utensil comprising a handle and a plurality of nested ring members in rotatable engagement with each other at an end portion of the handle. Each ring member has a recess defined in a first circumferential edge, and a projection extending from the circumferential edge to be received in and slidable along a corresponding recess of an adjacent ring member. A plurality of food-preparing elements is secured to the plurality of ring members, each food-preparing element being secured to a corresponding ring member. The food-preparing elements are movable from an expanded configuration to a collapsed configuration. Rotation of one or more of the ring members in a first direction moves the food-preparing elements to the expanded configuration, and rotation of one or more of the ring members in a second direction moves the food-preparing elements to the collapsed configuration.

In one embodiment, rotation of the ring members in the first direction moves the food-preparing elements to an expanded balloon configuration suitable for egg beating or food blending, and rotation of the ring members in the second direction moves the food-preparing elements to a collapsed planar configuration suitable for stir-frying of food. The food-preparing elements may be in the form of wire loops.

According to a further aspect of the invention, there is provided a method for food blending comprising the steps of (a) providing a food-preparing utensil comprising a handle, a plurality of nested ring members in rotatable engagement with each other at an end portion of the handle, each ring member having a recess defined in a circumferential edge, and a projection extending from the circumferential edge to be received in and slidable along a corresponding recess of an adjacent ring member, and a plurality of food-preparing elements secured to the plurality of ring members, each food-preparing element being secured to a corresponding ring member; (b) rotating the ring members in a first direction moves the food-preparing elements to an expanded balloon configuration suitable for food blending; and (c) rotating the ring members in a second direction moves the food-preparing elements to a collapsed planar configuration suitable for stir-frying of food.

According to yet another aspect of the invention, there is provided a method for stir-frying food comprising the steps of (a) providing a food-preparing utensil comprising a handle, a plurality of nested ring members in rotatable engagement with each other at an end portion of the handle, each ring member having a recess defined in a circumferential edge, and a projection extending from the circumferential edge to be received in and slidable along a corresponding recess of an adjacent ring member, and a plurality of food-preparing elements secured to the plurality of ring members, each food-preparing element being secured to a corresponding ring member; (b) rotating the ring members in a first direction moves the food-preparing elements to an expanded balloon configuration suitable for food blending; and (c) rotating of the ring members in a second direction moves the food-preparing elements to a collapsed planar configuration suitable for stir-frying of food.

### BRIEF DESCRIPTION OF THE DRAWINGS

Specific embodiments of the invention will now be described by way of example with reference to the accompanying drawings.

FIG. 1 is a perspective view of a whisk in an expanded balloon configuration according to an embodiment of the present invention.

FIG. 2 is a side view of the whisk of FIG. 1.

FIG. 3 is a top view of the whisk of FIG. 1.

FIG. 4 is a perspective view of a whisk in a collapsed planar configuration according to an embodiment of the present invention.

FIG. 5 is a front view of the whisk of FIG. 4.

FIG. 6 is a top view of the whisk of FIG. 4.

FIG. 7 shows five wire loops of the whisk according to an embodiment of the present invention.

FIG. 8 is shows the ring members, the coupling member, the knob and the handle of the whisk according to an embodiment of the present invention.

FIG. 9 is an exploded view of the ring members, the coupling member, the knob and the handle of the whisk shown in FIG. 8.

FIG. 10 is a perspective view of a wire loop being secured to ring member of the whisk according to an embodiment of the present invention.

FIG. 11 is a side view of the wire loop being secured to ring member illustrated in FIG. 10

FIG. 12 is a side view of the whisk in a collapsed planar configuration.

FIG. 13 is a longitudinal cross sectional view taken along line A-A of the whisk shown in FIG. 12.

FIG. 14 is a perspective view of a ring member according to an embodiment of the present invention.

FIG. 15 is a side view of the ring member of FIG. 14.

FIG. 16 is a top view of the ring member of FIG. 14.

FIGS. 17(a), (b) and (c) are bottom views of the nested ring members changing from collapsed planar configuration towards expanded balloon configuration.

FIGS. 17(d), (e) and (f) are corresponding top views of the nested ring members of FIGS. 17(a), (b) and (c).

FIGS. 18 (a), (b) and (c) show a front view of the whisk, a bottom view of the nested ring members and a perspective view of the whisk respectively in a collapsed planar configuration.

FIGS. 19 (a), (b) and (c) are similar views of the whisk in FIGS. 18 (a), (b) and (c) showing the first stage of rotation of the ring members.

FIGS. 20 (a), (b) and (c) are similar views of the whisk in FIGS. 18 (a), (b) and (c) showing the second stage of rotation of the ring members.

FIGS. 21 (a), (b) and (c) are similar views of the whisk in FIGS. 18 (a), (b) and (c) showing the third stage of rotation of the ring members.

FIGS. 22 (a), (b) and (c) are similar views of the whisk in FIGS. 18 (a), (b) and (c) showing the whisk in an expanded balloon configuration.

### DETAILED DESCRIPTION OF THE INVENTION

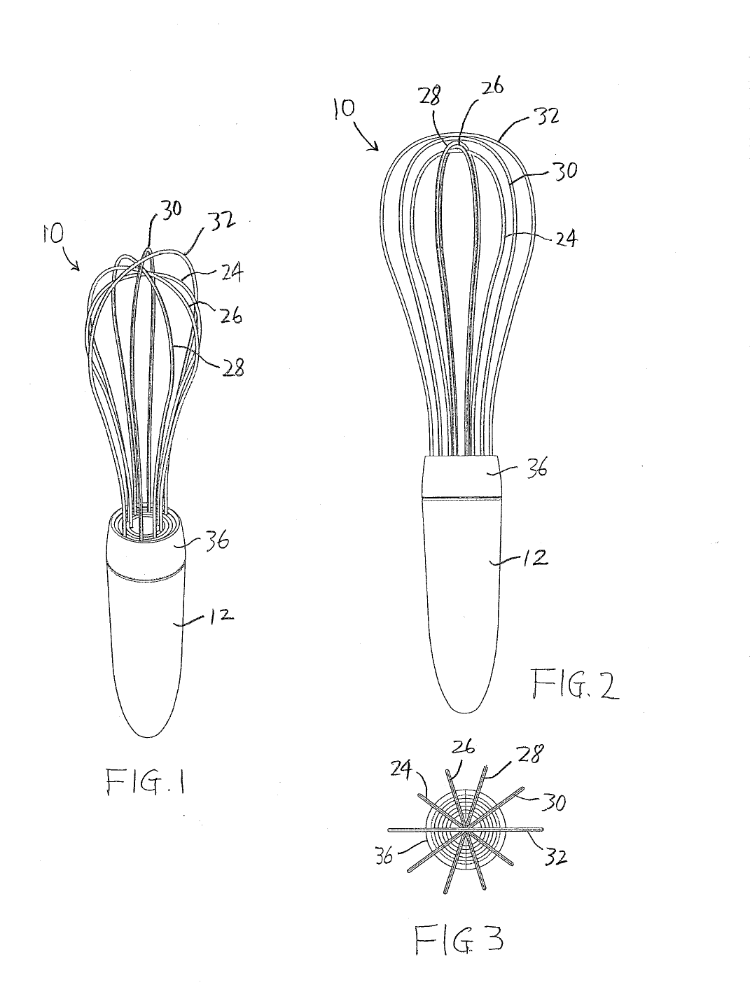

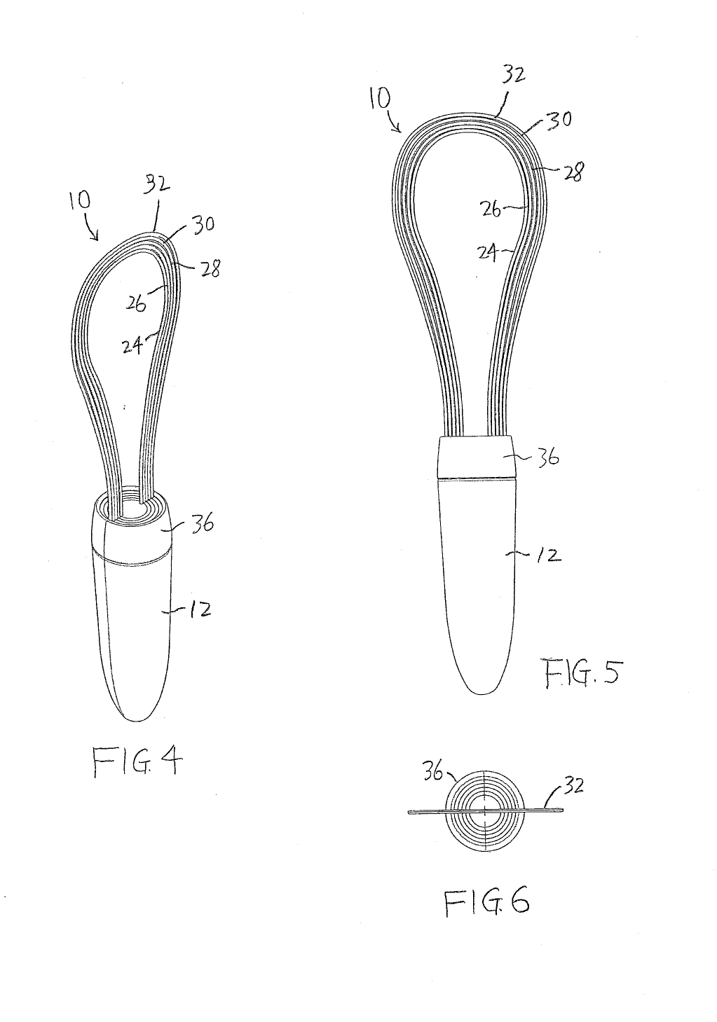

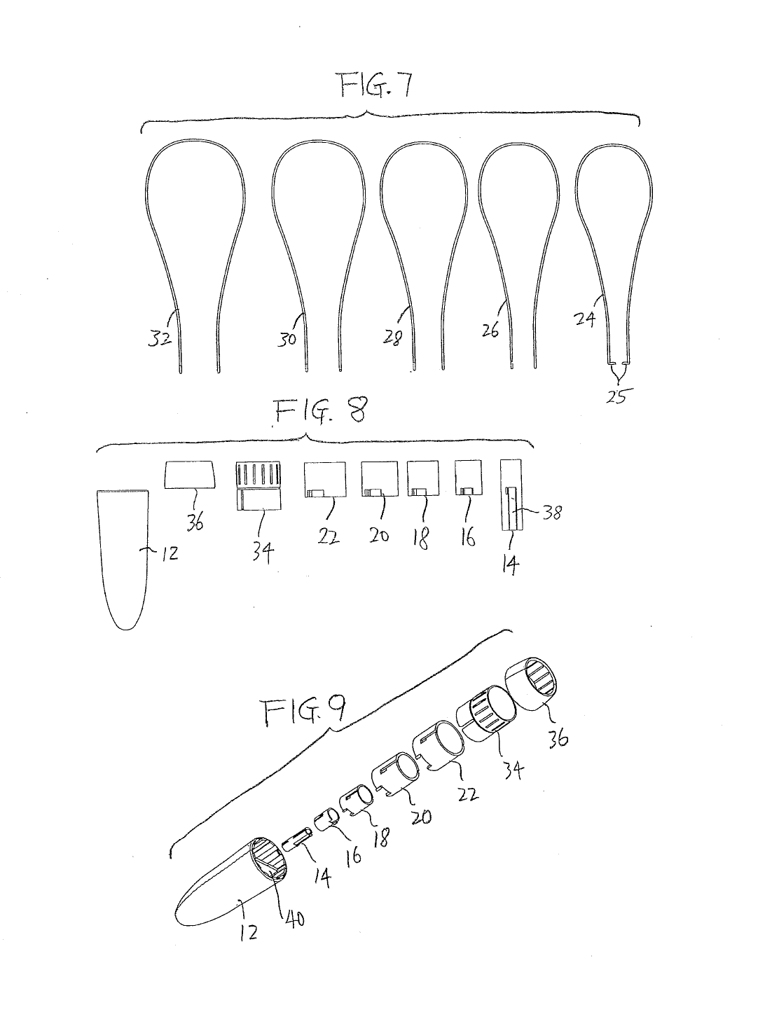

FIGS. 1-3 show different views of a whisk 10 according to an embodiment of the present invention. The whisk 10 may include a handle 12, a plurality of nested ring members 14, 16, 18, 20, 22 in rotatable engagement with each other at an end portion of the handle 12, and a whisk head in the form of a plurality of wire loops 24, 26, 28, 30, 32 secured to and extending from the plurality of ring members 14, 16, 18, 20, 22. Each wire loop 24, 26, 28, 30, 32 is secured to a corresponding ring member 14, 16, 18, 20, 22.

The innermost ring member 14 may be fixedly connected to the handle 12. Upon rotation of the ring members 16, 18, 20, 22 in a first direction (e.g. clockwise), the wire loops 24, 26, 28, 30, 32 can be moved to an expanded balloon configuration, as illustrated in FIGS. 1-3. The whisk 10 in this expanded balloon configuration is suitable for beating eggs, blending food, and whipping cream, etc. As used herein, the term “balloon” means the 3-dimensional balloon or teardrop shape of the wire loops of a traditional egg-beating wire whisk. A whisk having such a balloon-shaped whisk head is termed a “balloon whisk”.

Upon rotation of the ring members 16, 18, 20, 22 in an opposite second direction (e.g. anti-clockwise), the wire loops 24, 26, 28, 30, 32 can be moved to a collapsed planar configuration, as depicted in FIGS. 4-6. The whisk 10 in this collapsed planar configuration is suitable for use in stir frying, scooping up of food, etc.

According to the illustrated embodiment, there are five wire loops 24, 26, 28, 30, 32 secured to the five ring members 14, 16, 18, 20, 22 respectively, as best illustrated in FIGS. 7 and 8. The handle 12 and the ring members 14, 16, 18, 20, 22 may be made of plastic or any other suitable material. The wire loops 24, 26, 28, 30, 32 may be made of metal, or plastic, or silicone coated for non-stick pans.

As best illustrated in FIG. 9, the ring member 14 can be nested within the ring member 16, which in turn can be nested within the ring member 18, which in turn can be nested within the ring member 20, which in turn can be nested within the ring member 22. The outermost ring member 22 may be coupled with an annular knob 36 by a tubular coupling member 34. The outermost ring member 22 may be nested within the tubular coupling member 34 at an inner portion thereof. The outer portion of the tubular coupling member 34 may be nested within the annular knob 36.

The innermost ring member 14 can be connected to the handle 12 in any possible way. According to the present embodiment, the innermost ring member 14 may have two opposite longitudinally extending slots 38 for fitting onto a longitudinal wall 40 extending diametrically inside the handle 12. The tubular coupling member 34, the annular knob 36 and the longitudinal wall 40 may also be made of plastic or any other suitable material.

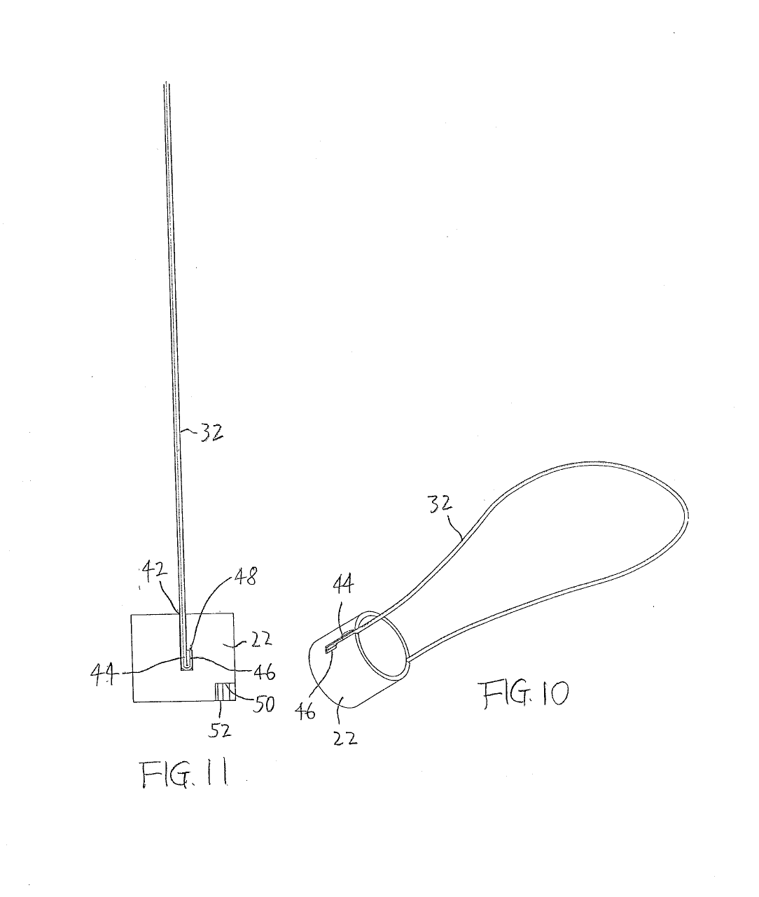

As illustrated in FIGS. 10 and 11, each ring member 14, 16, 18, 20, 22 may have two longitudinally extending grooves 42 defined in a second circumferential edge of the ring member for receiving two free ends 44 of a corresponding wire loop 24, 26, 28, 30, 32 respectively. According to the illustrated embodiment, the two longitudinal grooves 42 are positioned opposite each other in an outer circumferential edge of the ring member.

At least one free end 44 may have a bent portion 46 received in a void 48 extending in the circumferential direction from the longitudinally extending groove 42 such that the wire loops 24, 26, 28, 30, 32 are non-detachably connected to the ring members 14, 16, 18, 20, 22. According to the illustrated embodiment, the free end 44 of the wire loop 32 is bent into a U-shaped end. The innermost wire loop 24 may have two inwardly bending ends 25 instead for engagement with two corresponding recesses on the innermost ring member 14.

FIG. 12 shows a side view of the whisk 10 in the collapsed planar configuration, and FIG. 13 is a longitudinal cross sectional view of the whisk 10 in the collapsed planar configuration. It can be seen that the ring members 14, 16, 18, 20, 22 can be supported by the longitudinal wall 40.

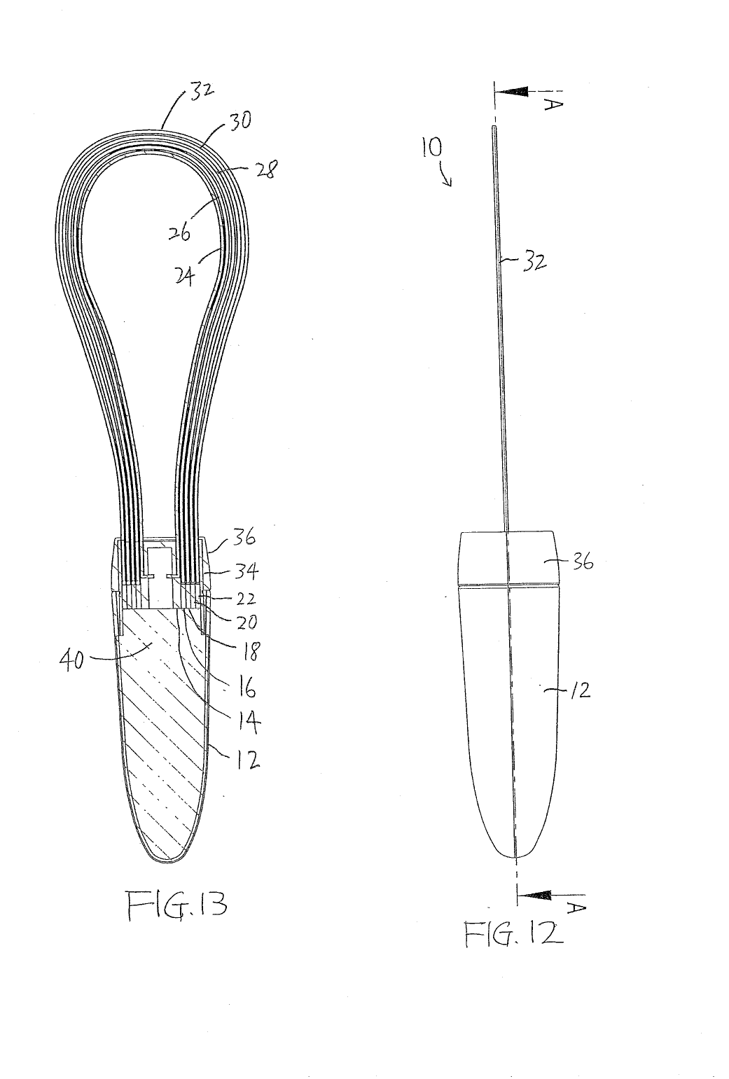

FIGS. 14-16 are different views showing the rotation mechanism of the ring members 14, 16, 18, 20, 22 according to an embodiment of the present invention. Each ring member 14, 16, 18, 20, 22 includes a recess 50 defined in a first circumferential edge of the ring member, and a projection 52 extending from the first circumferential edge of the ring member. According to the present embodiment, the projection 52 extends radially outwardly from the first circumferential edge of the ring member. The projection 52 can be received in and slidable along a corresponding recess of an adjacent ring member, whereby turning of an outer ring member drives an adjacent inner ring member to turn in the same direction.

Depending on the design and the size of the whisk, more or less than five wire loops can be provided on the whisk. Although loops of wires in balloon or teardrop shape are illustrated in the present embodiment, it is realized that the whisk 10 may be provided with other possible kinds of food-preparing elements and in any other possible shapes. For example, the whisk head of the whisk 10 may be provided with inverted U-shaped wires each having a pair of parallel, straight wire portions and a rounded head for preparing sauce as a sauce whisk. In another example, the whisk head of the whisk 10 may be provided with triangular wires each having a generally V-shaped body and a flat head for cooking on flat surfaces and reaching into corners of flat frying pans and cookware. In a further example, the whisk head of the whisk 10 may simply be provided with two straight wires extending outwardly from two opposite sides of each ring member. In a collapsed configuration, the whisk head of the whisk would look like a fork and can function as a fork.

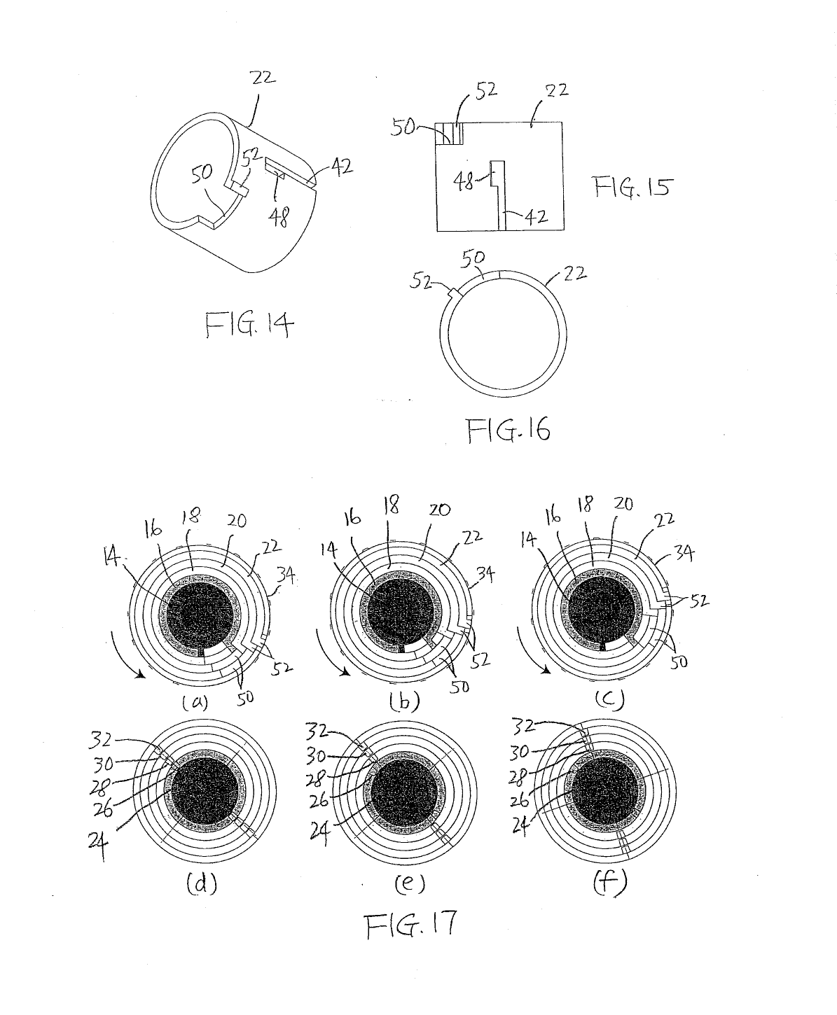

FIGS. 17 (a), (b) and (c) are bottom views of the nested ring members 14, 16, 18, 20, 22 showing some initial steps of changing the whisk head of the whisk 10 from a collapsed planar configuration to an expanded balloon configuration. FIGS. 17 (d), (e) and (f) are corresponding top views of FIGS. 17 (a), (b) and (c). According to the illustrated embodiment, when the annular knob 36 is turned anti-clockwise as shown by the arrows and viewed from the bottom views in FIGS. 17 (a), (b) and (c), the ring members 16, 18, 20, 22 start to turn anti-clockwise as viewed from the bottom views in FIGS. 17 (a), (b) and (c). As shown from the top views in FIGS. 17 (d), (e) and (f), when the annular knob 36 is turned clockwise, the wire loops 24, 26, 28, 30, 32 start to move from a collapsed planar configuration towards an expanded balloon configuration.

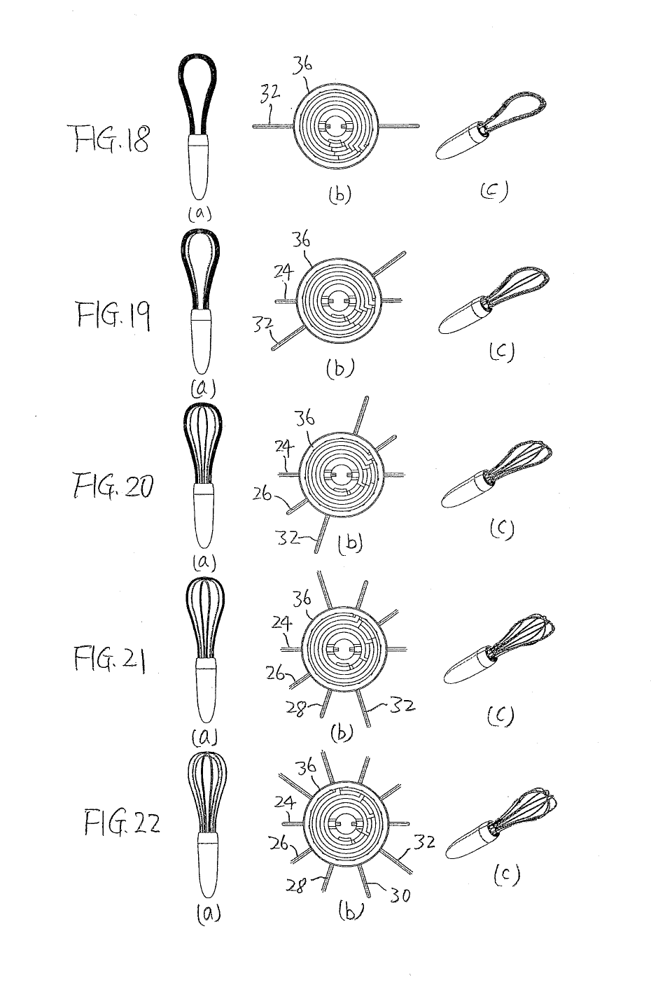

FIGS. 18 (a), (b) and (c) to FIGS. 22 (a), (b) and (c) show different views of the whisk 10 with the whisk head turning from a collapsed planar configuration to an expanded balloon configuration according to an embodiment of the present invention.

FIGS. 18 (a), (b) and (c) show different views of the whisk 10 with the whisk head in a fully collapsed planar configuration. When the annular knob 36 is turned about 36 degrees anti-clockwise, as viewed from the bottom view in FIG. 19 (b), the four ring members 16, 18, 20, 22 together with the four corresponding wire loops 26, 28, 30, 32 turn about 36 degrees. Since the innermost ring member 14 is fixed to the handle 12, the position of the innermost wire loop 24 does not change. At this point, the whisk head is partially expanded.

When the annular knob 36 is turned about 36 degrees further anti-clockwise, as viewed from the bottom view in FIG. 20 (b), the three ring members 18, 20, 22 together with the three corresponding wire loops 28, 30, 32 turn about 36 degrees further. At this point, the whisk head is still partially expanded.

When the annular knob 36 is turned about 36 degrees further anti-clockwise, as viewed from the bottom view in FIG. 21 (b), the two ring members 20, 22 together with the two corresponding wire loops 30, 32 turn about 36 degrees further. At this point, the whisk head is almost fully expanded.

Finally, when the annular knob 36 is turned about 36 degrees further anti-clockwise, as viewed from the bottom view in FIG. 22 (b), the remaining ring member 22 together with its corresponding wire loop 32 turn about 36 degrees further. At this point, the whisk head is in a fully expanded balloon configuration.

To change the whisk head of the whisk 10 from the fully expanded balloon configuration back to the collapsed planar configuration, a user can simply turn the annular knob 36 in the opposite direction. Although the changing of the whisk head from a collapsed planar configuration to an expanded balloon configuration has been illustrated in a number of steps, it is understood that the change of the whisk head from a collapsed planar configuration to an expanded balloon configuration would take only about 1-2 seconds. Similarly, the change of the whisk head from the fully expanded balloon configuration back to the fully collapsed planar configuration would also take about 1-2 seconds. The turning of the nested ring members 16, 18, 20, 22 may not necessary occur in a particular order but almost simultaneously.

It is contemplated that the whisk 10 of the present invention is a multi-purpose food-preparing utensil. The whisk 10 in the expanded balloon configuration can be used for beating eggs, mixing and blending of food, etc. The whisk 10 in the collapsed planar configuration can be used for stir-frying, scraping cooking food from the bottom and side of a pan, scooping up of food for serving and draining of oil, etc.

The whisk 10 of the present invention is versatile and easy to use. To make scrambled eggs, for example, a user first cracks a few eggs into a bowl. The user then sets the whisk head of the whisk 10 in an expanded balloon configuration and uses the whisk 10 with the expanded balloon-shaped whisk head as an egg beater to beat the eggs. The user may add milk, cream, salt and pepper into the eggs. The user can use the whisk 10 which is still in the expanded balloon configuration as a blender or mixer to mix and blend the eggs, milk, cream, salt and pepper together. The eggs mixture is then poured into a heating frying pan with some butter melting in it. The user then turns the annular knob 36 of the whisk 10 anti-clockwise and changes the whisk head from the expanded balloon configuration into a collapsed planar configuration. The user can use this whisk 10 with the collapsed planar whisk head as a spatula to stir the egg mixture in the frying pan and scrape the egg mixture from the bottom and side of the frying pan. Other ingredients such as sliced ham, chopped tomato and shredded cheese may be added at this time. Finally, the user can use the whisk 10 with the collapsed planar whisk head as a spoon to scoop up the cooked scrambled egg from the frying pan and then serve it in on a dish.

The whisk 10 of the present invention is easier and more convenient to clean than a traditional wire whisk. In a traditional wire whisk, the loops of wire are arranged in a fixed position relative to one another. It is difficult to clean these traditional wire whisks when food is trapped in the partially enclosed area defined by the wire loops and between the loops of wire especially at the lower ends of the loops of wire near the handle where the loops of wire are very close to each other in a rigid configuration. The whisk 10 of the present invention is easy to clean because the balloon-shaped wire loops can be changed into a collapsed configuration and any food trapped inside and between the wire loops can be removed easily.

Furthermore, the whisk 10 of the present invention is more durable and cost effective than traditional wire whisks. In a traditional wire whisk, all the wire loops, usually made of metal, are secured to one plastic part of the handle. That single plastic part is subject to wear and damage. However, in the whisk 10 of the present invention, each wire loop 24, 26, 28, 30, 32 is secured to an individual plastic ring member 14, 16, 18, 20, 22. This can reduce the likelihood of wear and damage to the ring members and make the whisk 10 more durable.

Also, the wire loops 24, 26, 28, 30, 32 of the whisk 10 of the present invention are non-detachably connected to the ring members 14, 16, 18, 20, 22. The wire loops 24, 26, 28, 30, 32 are unlike to become loose during food preparation. This makes the whisk 10 more reliable and efficient.

Finally, the whisk 10 of the present invention is collapsible, making it easy for storage and transportation.

While the invention has been shown and described with particular references to a number of preferred embodiments thereof, it should be noted that various other changes or modifications may be made without departing from the scope of the appended claims.

We claim:

1. A whisk having reconfigurable wire loops, the whisk comprising:
(a) a handle;
(b) a plurality of nested ring members in rotatable engagement with each other at an end portion of the handle, each ring member having a recess defined in a first circumferential edge of the ring member, and a projection extending from the first circumferential edge to be received in and slidable along a corresponding recess of an adjacent ring member, and
(c) a plurality of wire loops secured to the plurality of ring members, each wire loop being secured to a corresponding ring member;
(d) wherein the wire loops are movable from an expanded configuration to a collapsed configuration, and rotation of the ring members in a first direction moves the wire loops to the expanded configuration, and rotation of the ring members in a second direction moves the wire loops to the collapsed configuration.

2. The whisk as claimed in claim 1, wherein the wire loops in the expanded configuration are generally balloon-shaped suitable for egg beating or food blending.

3. The whisk as claimed in claim 1, wherein the wire loops in the collapsed configuration are generally planar suitable for stir-frying of food.

4. The whisk as claimed in claim 1, wherein the plurality of ring members includes an innermost ring member fixedly connected to the handle, and an outermost ring member coupled with and rotatable by an annular knob.

5. The whisk as claimed in claim 4, wherein the annular knob is coupled with the outermost ring member by a tubular coupling member.

6. The whisk as claimed in claim 1, wherein each ring member comprises two longitudinal grooves defined in a second circumferential edge of the ring member for receiving therein respectively two free ends of a corresponding wire loop.

7. The whisk as claimed in claim 6, wherein at least one free end of each wire loop has a bent portion received in a void extending in a circumferential direction from one of the longitudinal grooves such that the plurality of wire loops is non-detachably connected to the ring members.

8. The whisk as claimed in claim 6, wherein the two longitudinal grooves are positioned opposite each other in the second circumferential edge.

9. The whisk as claimed in claim 1, wherein each projection extends radially outwardly, and is received in and slidable along a corresponding recess of an outer adjacent ring member.

10. The whisk as claimed in claim 1, wherein the plurality of ring members includes an innermost ring member having an elongated inner end formed with two opposite longitudinal slots for fitting onto a longitudinal wall extending diametrically inside the handle.

11. The whisk as claimed in claim 1, comprising five wire loops secured to five nested ring members, respectively.

12. The whisk as claimed in claim 1, wherein the first direction is a clockwise direction and the second direction is an anti-clockwise direction.

13. A multi-purpose food-preparing utensil comprising:
(a) a handle;
(b) a plurality of nested ring members in rotatable engagement with each other at an end portion of the handle, each ring member having a recess defined in a first circumferential edge of the ring member, and a projection extending from the first circumferential edge to be received in and slidable along a corresponding recess of an adjacent ring member, and
(c) a plurality of food-preparing elements secured to the plurality of ring members, each food-preparing element being secured to a corresponding ring member;
(d) wherein the food-preparing elements are movable from an expanded configuration to a collapsed configuration, and rotation of one or more of the ring members in a first direction moves the food-preparing elements to the expanded configuration, and rotation of one or more of the ring members in a second direction moves the food-preparing elements to the collapsed configuration.

14. The utensil as claimed in claim 13, wherein rotation of the ring members in the first direction moves the food-preparing elements to an expanded balloon configuration suitable for egg beating or food blending, and rotation of the ring members in the second direction moves the food-preparing elements to a collapsed planar configuration suitable for stir-frying of food.

15. The utensil as claimed in claim 13, wherein the food-preparing elements are in the form of wire loops.

16. The utensil as claimed in claim 13, wherein the plurality of ring members includes an innermost ring member fixedly connected to the handle, and an outermost ring member coupled with and rotatable by an annular knob.

17. The utensil as claimed in claim 16, wherein the annular knob is coupled with the outermost ring member by a tubular coupling member.

18. The utensil as claimed in claim 13, each ring member comprises two longitudinal grooves defined in a second circumferential edge of the ring member for receiving therein respectively two free ends of a corresponding food-preparing element.

19. The utensil as claimed in claim 18, wherein at least one free end of each food-preparing element has a bent portion received in a void extending in a circumferential direction from one of the longitudinal grooves such that the plurality of food-preparing elements is non-detachably connected to the ring members.

20. The utensil as claimed in claim 18, wherein the two longitudinal grooves are positioned opposite each other in the second circumferential edge.

21. The utensil as claimed in claim 13, wherein each projection extends radially outwardly, and is received in and slidable along a corresponding recess of an outer adjacent ring member.

22. The utensil as claimed in claim 13, wherein the first direction is a clockwise direction and the second direction is an anti-clockwise direction.

23. A method for food blending comprising the steps of:
(a) providing a food-preparing utensil comprising a handle, a plurality of nested ring members in rotatable engagement with each other at an end portion of the handle, each ring member having a recess defined in a circumferential edge, and a projection extending from the circumferential edge to be received in and slidable along a corresponding recess of an adjacent ring member, and a plurality of food-preparing elements secured to the plurality of ring members, each food-preparing element being secured to a corresponding ring member;
(b) rotating the ring members in a first direction moves the food-preparing elements to an expanded balloon configuration suitable for food blending or egg beating; and
(c) rotating the ring members in a second direction moves the food-preparing elements to a collapsed planar configuration suitable for stir-frying of food.

24. A method for stir-frying food comprising the steps of:
(a) providing a food-preparing utensil comprising a handle, a plurality of nested ring members in rotatable engagement with each other at an end portion of the handle, each ring member having a recess defined in a circumferential edge, and a projection extending from the circumferential edge to be received in and slidable along a corresponding recess of an adjacent ring member, and a plurality of food-preparing elements secured to the plurality of ring members, each food-preparing element being secured to a corresponding ring member;
(b) rotating the ring members in a first direction moves the food-preparing elements to an expanded balloon configuration suitable for food blending or egg beating; and
(c) rotating of the ring members in a second direction moves the food-preparing elements to a collapsed planar configuration suitable for stir-frying of food.
